(19) United States
(12) Patent Application Publication
(10) Pub. No.: US 2010/0326606 A1
(43) Pub. Date: Dec. 30, 2010

(54) Composite sound absorbing blind systems

(76) Inventors: Arthur P. Barkman, Hillsborough, NJ (US); Michael Kemp, Pittstown, NJ (US)

Correspondence Address: Deirdra M. Meagher, 6 Minneakoning Road, Flemington, NJ, 08822, US

(21) Appl. No.: 12/804,974

(22) Filed: Aug. 3, 2010

Related U.S. Application Data
(63) Continuation-in-part of application No. 12/082,756, filed on Apr. 14, 2008.
Application No. 12/082,756 is a continuation-in-part of application No. 11/071,813, filed on Mar. 3, 2005.

(51) Int. Cl. E06B 9/386

(52) U.S. Cl. 160/188

(57) ABSTRACT

The present invention provides a sound absorbing blind system. It includes a support means for a plurality of window blinds, a plurality of window blinds and operational means connected to the support means and to the plurality of window blinds for opening and closing the plurality of window blinds. Each of the plurality of window blinds is adapted for sound absorption and each of the plurality of window blinds is an acoustically and insulatively absorptive, unistructural member having a noise reduction coefficient of at least 0.60 when said plurality of blinds are closed. The plurality of window blinds is constructed of at least one layer of material, with blinds composed of multiple materials remaining a unistructural member. The blinds are described without the need for rigid extruded plastic or metal blinds or blind substrates used in conventional blinds of the prior art, simplifying manufacturing while improving sound absorption properties of the present invention blinds system.

### REFERENCE TO RELATED APPLICATION

This application is a continuation in part of copending U.S. patent application Ser. No. 12/082,756 filed on Apr. 14, 2008 by the same inventors herein and entitled “Sound Absorbing Blind System”, which is itself a continuation in part of copending U.S. patent application Ser. No. 11/071,813 filed on Mar. 3, 2005 by the same inventors herein and entitled “Sound Absorbing Composite Blind System”.

### BACKGROUND OF INVENTION

a. Field of Invention

The invention relates generally to window blinds, doorway blinds, divider blinds and other blinds that are opened and closed to permit/prevent light entry and/or create/remove privacy. More specifically, the present invention relates to blind systems of the above types wherein these blinds systems advantageously absorb sound to decrease echoing, reverberations, distortions, etc. in the surrounding environment without the need for rigid extruded plastic or metal blinds or blind substrates previously used in conventional blinds of the prior art. This simplifies manufacturing while improving sound absorption properties of the present invention blinds system.

b. Description of Related Art

The following patents are representative of the field pertaining to the present invention:

U.S. Pat. No. 2,590,204 to H. K. Phillips describes an acoustical Venetian blind and slat that is constructed as to have acoustical properties so that the slats of the blinds will absorb sound waves impinging thereagainst. Each slat is constructed with suitable insulating properties such as insulating fibers to absorb and trap sound waves and prevent such sound waves from passing through the blind. When the slats are in a slanted position sound waves will reflect from one side of the slat and will bounce against the under surface of an adjacent slat and be absorbed by the acoustical material and will not pass through the blinds. A unistructural slat is described in which a sound absorbing material such as fiberglass is compressed into a solid sheet to form a slat of a desired size and shape.

U.S. Pat. No. 2,855,039 to E. H. Gross describes a sound absorbent structure directed at the reduction or minimizing of the passage of sound waves through openings, such as the windows of a building, with the view to eliminating street or similar noises. It has further object the reduction of noise-penetration without undue interference with the admission of air and light through such openings. A slatted structure having individual slats adjustable mounted to permit light and air between the slats is provided. Each slat has a core of sound-absorptive material and a skin or covering of sound-deadening material. Alternatively, a thermoplastic material can comprise both the core and the sheathing of a slat by incorporating conventional blowing or foaming agents in the plastic to produce a continuous outer skin of plastic united to an interior core of foamed or cellular plastic. Improvements can be attained when the skin is separated as by spacers from the core to form air pockets. This non-unistructural embodiment is shown to produce a noise reduction coefficient of 0.70-0.80 in one example provided using a rigid metal shell.

U.S. Pat. No. 4,276,954 to Paul L. Romano describes an adjustable light and air-admitting thermal and acoustic barrier that has a plurality of sound-attenuating blades pivotally mounted in a frame in a mutually spaced, parallel relationship. When the barrier is mounted at an open window, the blades may be adjusted to various open positions to allow desired amounts of outside light and air into a room, but cooperate in such open positions to form an effective sound trap for annoying outside sounds. Each of the blades functions as both a sound absorber and a sound transmission barrier, and comprises an elongated, relatively thin core of solid, sound-reflective material having longitudinally extending edge and intermediate flanges which define cavities on opposite sides of the core. Secured within the cavities by the flanges are strips of sound-absorbing insulating material, the core and insulating material being laterally enfolded by a cover secured to the flanges. When the blades are in their fully closed position, they form a thermal barrier to reduce heat gain or loss through the window. A core of solid material is key in attaining the acoustic barrier described by U.S. Pat. No. 4,276,954.

U.S. Pat. No. 4,773,958 to Barry I. Goodman describes laminates which are comprised of strand material that is not free hanging and in which there are substantial spaces between the strands to allow light to pass through the material, and a sheet-like layer to which the strand material is secured so that the strands of the laminate are fixed. The laminates allow the color of the characteristics of a slat member or insert to be seen. The laminates can have differing surface characteristics, (e.g. texture) and strand colors, sizes and patterns. The sheet-like layer can be transparent or translucent. A laminate can be secured directly, for example by adhesive, to a slat member having light-transmitting properties (e.g. opaque or translucent), surface characteristics (e.g. texture), and/or color which affect the overall appearance of the slat. A laminate can be removably secured to a grooved slat member that can have light-transmitting properties, surface characteristics and/or color that affect the overall appearance of the slat. An insert can be disposed between the laminate and the grooved slat which itself has light-transmitting properties (e.g. opaque, translucent), surface characteristics and/or color or print which affect the overall appearance of the slat. The laminate allows the insert and/or slat member to be seen, to provide color, etc. to the slat assembly. The laminates allow a vertical blind slat to be assembled easily from a particular laminate and slat member, and insert if used. By stocking a limited number of laminates, slat members and inserts, a wide variety of slat assemblies can be provided. The laminates can have a plastic or fabric second layer to which the strand material is secured. Unlike the present invention, U.S. Pat. No. 4,773,958 does not provide for a unistructure slat.

U.S. Pat. No. 4,884,615 to Henry C. Hsu describes a slat for use in the assembly of a Venetian blind that is provided with a light and sound absorptive coating on at least one if its major surfaces produced by flecking, appliqué, or textile weaving techniques, a preferred embodiment of the invention providing a strip having enhanced resistance to slippage of a coating appliquéd to the strip and of a textile encapsulation of the strip in directions laterally and longitudinally of the strip.

U.S. Pat. No. 6,446,751 to Krishan K. Ahuja et al. describes a flexible sound shielding curtain that contains a plurality of sound insulating sheet inserts encased within pockets or otherwise secured on the exterior surfaces of the panels of a curtain. The sound insulating sheet inserts may be constructed of a combination of materials selected and configured such that sound impinging upon the curtain is absorbed or alternatively reflected. The sound shielding curtain can be tuned to insulate an area from a select range of frequencies inherent in select environments. Turning may be accomplished through the selection and installation of sound insulating sheet inserts configured to reflect or absorb audible acoustical energy. The sound insulating sheet inserts are readily removable to permit periodic laundering of the curtain fabric and to provide adaptability for a number of applications. Sound shielding curtain(s) can be selected, configured, installed, and extended in such a manner as to provide sound reduction in a localized space. The sound shielding curtain(s) may also be configured with a view window by replacing a portion of one or more sound insulating sheets with an acoustically hard transparent material. The acoustically hard material may also comprise a panel of controllable privacy film.

U.S. Pat. No. 6,497,266 B1 to Roger Palmer et al. describes a window covering that includes a plurality of slats, each slat including a slat base derived from a felt batt and, in one preferred embodiment, a fabric layer. The slat base is thermally treated to form a polymer matrix and can be molded into any desired shape. The starting felt batt includes at least two types of thermoplastic fibers, one having a lower melting point than the other. The thermal forming includes heating the felt batt to a temperature sufficient to melt the lower melting fibers to form a polymer matrix, which at least partially envelops the fibers of the higher melting component. A method of fabricating a slat for a window covering is also disclosed. In its most basic form the method includes the steps of thermally forming the slat base and molding it into the desired shape. The optional step of securing a layer of fabric to the slat is also disclosed.

U.S. Pat. No. 6,598,650 B1 to Roger C. Palmer describes a rigid hollow vane for door or window coverings that includes a vane shell and an optional fabric covering. The shell is thermally formed and results in a polymer matrix at least partially enveloping the fibers. In its most preferred form, the polymer matrix results from heating a batt of two types of fibers, the one type having a lower melting point than the remaining fibers, so that a rigid polymer matrix can be formed about other fibers in the batt.

U.S. Pat. No. 6,615,951 to Claude Boutin et al. describes an invention that concerns an absorbent material consisting of a porous matter with open porosity characterized in that it comprises a plurality of perforations with varied transverse cross-section end positioned at an angle relative to a specific dimension of the material, thereby providing additional porosity to the material.

United States Patent Application Publication No. 2006/0113046 A1 to Kendall W. Prince et al. describes a window-covering component comprising a substrate having a modulus of elasticity and a stiffener having a higher modulus of elasticity than the substrate and positioned substantially away from the plane in which the substrate would otherwise tend to deform.

Notwithstanding the prior art, the present invention is neither taught nor rendered obvious thereby.

### SUMMARY OF INVENTION

The present invention solves the problems and overcomes the drawbacks and deficiencies of the prior art by providing a sound absorbing blind system. It includes support means for a plurality of window blinds, operational means connected to the support means and to the plurality of window blinds for opening and closing the plurality of window blinds and the plurality of window blinds connected to the support means and the operational means. Each of the plurality of window blinds is adapted for sound absorption, and each of the plurality of window blinds is an acoustically and insulatively absorptive, single layer material having a noise reduction coefficient of at least 0.60 when the plurality of blinds are closed.

In some preferred embodiments of the present invention sound absorbing blind system, each of the plurality of window blinds is a unistructural blind that functions as a single element.

In some preferred embodiments of the present invention sound absorbing blind system, the plurality of window blinds material is a fiber glass material selected from the group consisting of compression molded fiber glass, spun fiber glass and swirled mat fiber glass.

In some preferred embodiments of the present invention sound absorbing blind system, the plurality of window blinds material is a foam material selected from the group consisting of at least partially open pore urethane foam and at least partially open pore polyester foam.

In some preferred embodiments of the present invention sound absorbing blind system, the plurality of window blinds material is a mat material selected from the group consisting of inorganic mat, organic mat and combinations thereof.

In some preferred embodiments of the present invention sound absorbing blind system, each blind of the plurality of blinds includes two opposing elongated enclosure channels that receive and hold peripheral edges of the blind.

In some preferred embodiments of the present invention sound absorbing blind system, each blind of the plurality of window blinds has a thickness of about 0.15 inches to about 0.5 inches.

In some preferred embodiments of the present invention sound absorbing blind system, the plurality of window blinds material has a density of about 4 pounds per cubic foot to about 9 pounds per cubic foot.

In some preferred embodiments of the present invention sound absorbing blind system the plurality of window blinds are selected from the group consisting of vertical blinds, horizontal blinds and angled blinds.

In some preferred embodiments of the present invention sound absorbing blind system, the plurality of window blinds are constructed without the need for rigid extruded plastic or metal blinds or blind substrates.

In some other preferred embodiments, the present invention is directed to a sound absorbing blind system that includes a support means for a plurality of window blinds, operational means connected to the support means and to the plurality of window blinds for opening and closing the plurality of window blinds, the plurality of window blinds connected to the support means and the operational means. Each of the plurality of window blinds is adapted for sound absorption, and each of the plurality of window blinds is an acoustically and insulatively absorptive, multiple layer material having a noise reduction coefficient of at least 0.60 when the plurality of blinds is closed.

Additional features, advantages, and embodiments of the present invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 a partial cut, front view of one embodiment of the present invention sound absorbing blind system;

FIG. 2 shows a top cut view of one preferred blind used in the present invention sound absorbing blind system;

FIG. 3 shows a top cut view of an embodiment of the present invention sound absorbing blinds;

FIG. 4 shows a top cut partial view of an embodiment of the present invention sound absorbing blinds;

FIG. 5 show a front view of an embodiment of the present invention sound absorbing blind systems;

FIG. 6 show a front view of an alternate embodiment of the present invention sound absorbing blind systems;

FIG. 7 show graphic test results for noise reduction coefficients of the present invention sound absorbing blind system in an open position;

FIG. 8 show graphic test results for noise reduction coefficients of the present invention sound absorbing blind system in a closed position; and

FIG. 9 illustrates a partial oblique view of another preferred embodiment of the present invention sound absorbing blind.

### DETAILED DESCRIPTION OF THE EMBODIMENTS

Referring now to the drawings wherein like reference numerals designate corresponding parts throughout the several views.

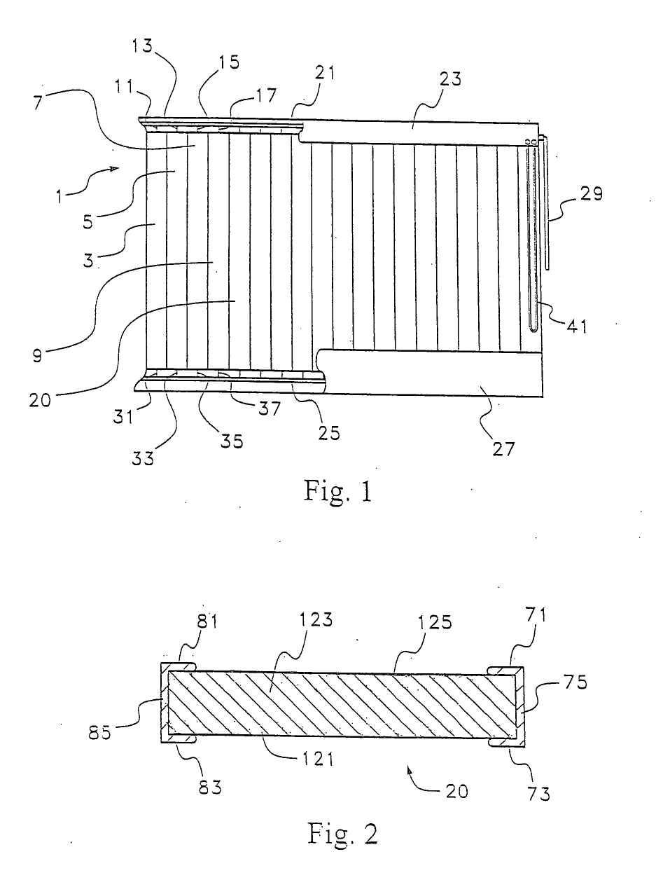

FIG. 1 shows a partial cut, front view of a present invention sound absorbing blind system 1. It includes a plurality of individual vertical blinds, e.g., 3, 5, 7, 9 and 20. These blinds are mounted in a frame that has a horizontal top housing 23 and an optional horizontal bottom housing 27, with tracks 21 and 25, respectively. Each blind has an upper fittages that comprises a vertical attachment connected to a track support that may be slid left to right and right to left on the tracks and may be rotated. These may be any of a number of known system supports used with conventional vertical blinds the details of which are within the purview of the artisan. Thus blinds 3, 5, 7 and 9, for example, have upper fittages 11, 13, 15 and 17 respectively, and optional lower fittages 31, 33, 35 and 37, respectively. A user would rotate rod 29 to rotate the blinds by these fittages for stationary (fixed axis) opening and closing, and would pull on the one side or the other of cord 41 to slide open and to slide close these blinds along the track (linear movement).

FIG. 2 shows a top cut view of one preferred blind used in a present invention sound absorbing blind system 1 shown in FIG. 1. FIG. 2 thus shows blind 20 from system 1 in FIG. 1, in a top cut view. There is one layer of material 123 cut in elongated rectangular shape, and having a front 121 and a back 125. The material 123 is acoustically and insulativly absorptive, as well as being unistructural. Unistructural as it is used in this application is used to describe a blind that functions as one structure regardless of the number of layers used in the creation of the blind, with individual layers being formed together as one inseparable blind. This usage is derived from the definition of uni—, one or single, and structure, being arranged in a definitive pattern of organization, from Webster's Ninth New Collegiate Dictionary. Furthermore, the material 123 has a noise reduction coefficient of at least 0.60 when the plurality of blinds are closed. In this embodiment, the material 123 is a compression-molded mat of glass fibers with phenolic resins (e.g. phenol formaldehyde) commonly know as fiberglass. This material has a density of about 5 pounds per cubic foot to about 9 pounds per cubic foot. Other materials, such as spun fiberglass and swirled mat fiberglass, may be substituted for the mat. The material 123 is usually semi-flexible but may stand on its own like foam or cardboard, such as partially open pore urethane foam and at least partially open pore polyester foam. Furthermore, the material 123 may be a mat including inorganic mat, organic mat and combinations thereof. The material 123 is supported by a frame in the form of side and top and bottom enclosure channels. In this FIG. 2, the enclosure channels 75 and 85 are shown and these have right-angled ends 71 and 73, and 81 and 83, respectively, to hold the material 123 in place.

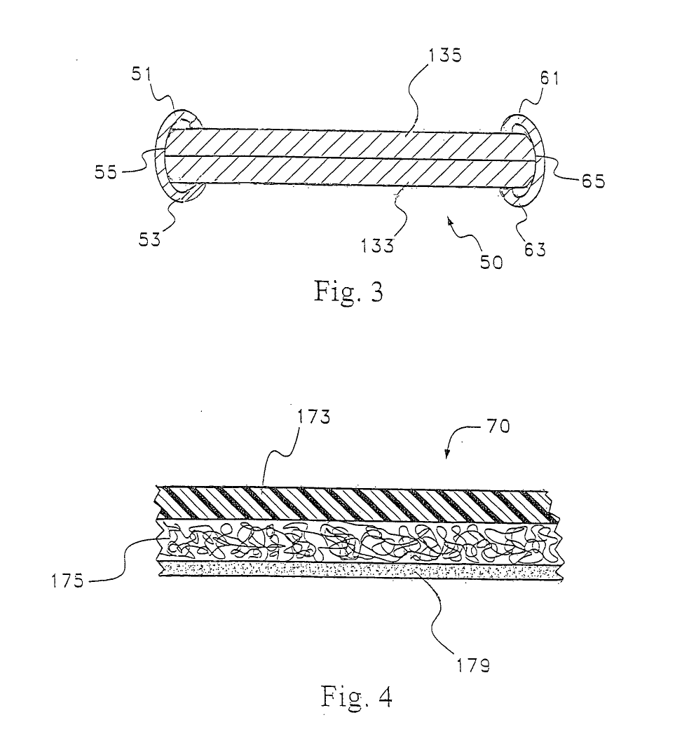

FIG. 3 shows a top cut view of present invention blind 50. It has at least two diverse layers 133 and 135 of material, diverse layer 133 being a partially open pore polyurethane semi-flexible foam, and diverse layer 135 being a felt mat. The at least two diverse layers 133 and 135 are both acoustically and insulatively absorptive and together are a unistructure element. The material selections for the at least two diverse layers 133 and 135 are the same as described by FIG. 2 above. Enclosure channels 65 and 55 are shown as semi-ellipses with curved ends 61, 63, 51 and 53 to hold materials 133 and 135 in place.

FIG. 4 shows present invention blind 70 with three diverse layers 173, 175 and 179 of material. Diverse layer 173 is semi-porous polyester foam while diverse layer 175 is a spun glass fiber mat and diverse layer 179 is an organic mat. The at least three diverse layers 173, 175 and 179 are all acoustically and insulatively absorptive and together are a unistructure. The material selections for the at least three diverse layers 173, 175 and 179 are the same as described by FIG. 2 above.

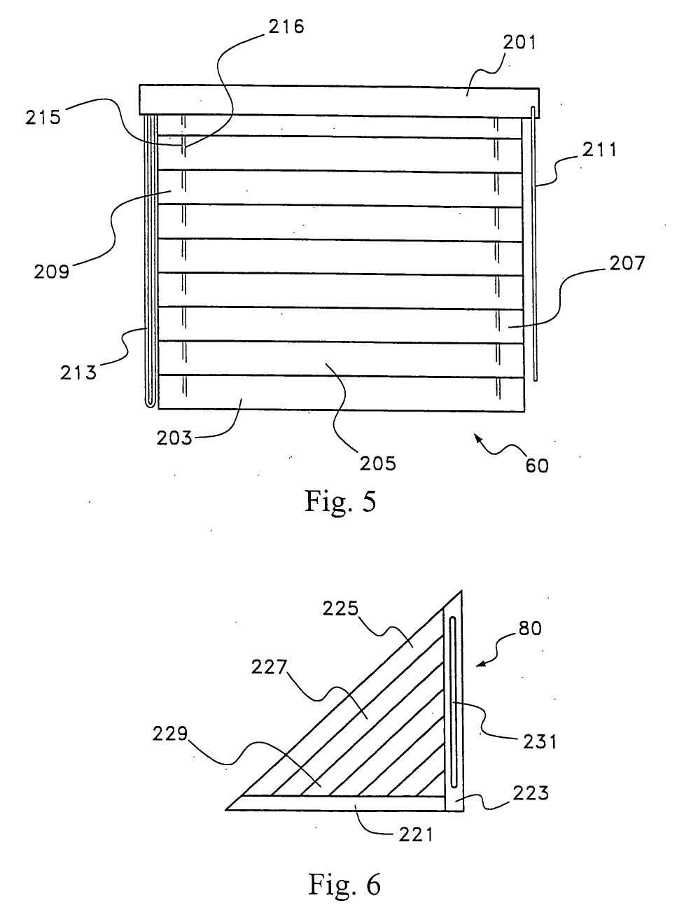

FIG. 5 shows a front view of an embodiment of present invention sound absorbing blind systems consisting of horizontal blind system 60 with horizontal blinds 203, 205, 207, 209, etc. There is an optional top housing 201 (and no bottom housing) with connecting lines such as lines 215 and 216 that connect top housing 201 to the horizontal blinds 203, 205, 207, 209, etc. to permit opening and closing and raising and lowering of the blinds 203, 205, 207, 209, etc. The cord 213 is used for raising and lowering, and the rod 211 is twisted for opening and closing the blinds on a fixed axis. The blinds themselves 203, 205, 207, 209, etc. are of the type shown in FIG. 3.

FIG. 6 shows present invention blind system 80 for a right triangle window. The blinds 225, 227, 229, etc. do not slide in this embodiment but only rotate. The blinds 225, 227, 229, etc. have connections inside horizontal housing 221 and vertical housing 231 and are rotated in plane to open and close, by rotation of rod 223. These blinds 225, 227, 229, etc. have a construction as shown in FIG. 4 above.

All of the blinds shown and described in the Figures above have a noise reduction coefficient of over 0.60, which represents a significant improvement over prior art for a unistructure blind. (Noise reduction coefficient is the average of the coefficients measured at 250, 500, 1000 and 2000 Hz.)

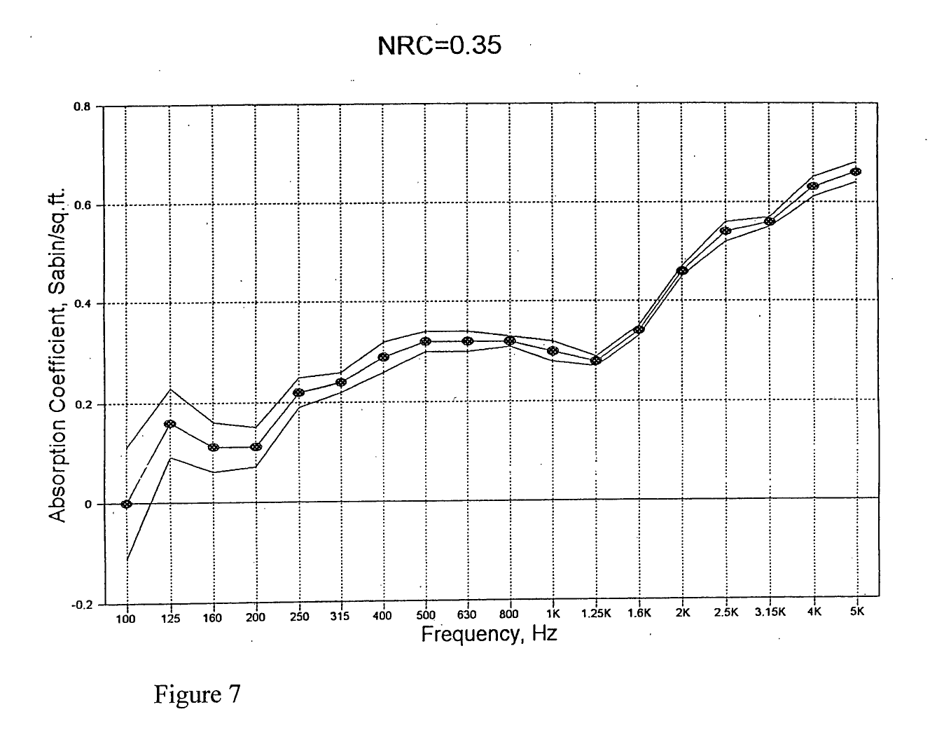

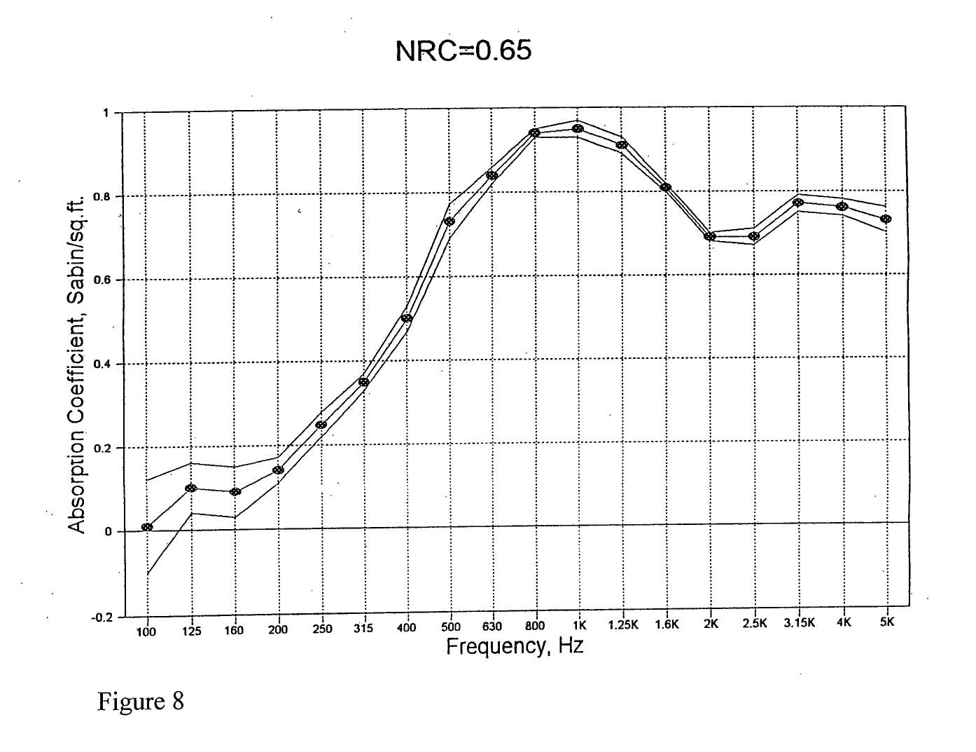

FIGS. 7 and 8 show graphic test results for noise reduction coefficients of a present invention sound absorbing blind system shown in FIGS. 1 and 2 in open and closed positions respectively. These tests were conducted on a window with measurements from inside a room.

The sound adsorption coefficient of a surface in a specified frequency band is, aside from the effects of diffraction, the fraction of randomly incident sound energy absorbed or otherwise not reflected. The unit of measurement is Sabin per square foot.

The noise reduction coefficient, NRC, is the average of the sound absorption coefficients at 250, 500, 1000 and 2000 Hz expressed to the nearest integral multiple of 0.05. Measurements were made according to: ASTM Designation: C 423-90 g, “Standard Test Method for Sound Absorption and Sound Absorption Coefficients by the Reverberation Room Method.” Standard Mountings are defined in: ASTM Designation: E 795-91, “Standard Practices for Mounting Test Specimens During Sound Absorption Test.”

The test specimen consisted of 48 vertical blind strips, each strip being 3¾″ wide by 71¾″ long by ¼″ thick. The strips were mounted in channels as described above. The mounting fixture consisted of three wooden frames enclosed on four sides. Each frame's inside dimensions were 48″ by 72″. The three frames were placed against the test room wall adjacent each other, forming a continuous test specimen 6′ high and 12′ wide. The vertical blind strips were hung on 3″ centers from cup hooks screwed into the top of each wooden frame. The line along which the cup hooks were secured was 2⅝″ from the test wall surface. The cracks between the top rear edges of the wooden frames and the test surface was sealed with duct tape to prevent sound from entering from the top. The blind strips were positioned in the open configuration, at a 90° angle from the test surface, and subsequently in the fully closed position.

The specimen, identified as “Vertical Blind Strips” was submitted for testing by Arthur Barkman. The weight of the specimen was 23.5 pounds. The area used to calculate absorption coefficients was 72 square feet, the face area of the specimen.

The calculated values of the sound absorption of the specimen and sound absorption coefficients together with the calculated measurement uncertainty for each are tabulated in Table 1 and Table 2 below for open and closed blinds, respectively. FIGS. 7 and 8 show the results graphically for open and closed blinds. Point dots are data points and upper and lower lines on these graphs are deviation lines. Results were more than double the NRC of standard blinds and represent a significant improvement over the prior art.

TABLE 1
PRESENT INVENTION BLINDS OPEN

| Frequency | Absorption | Devia- | Coefficient | Devia- |
|---|---|---|---|---|
| (Hz) | (Sabin) | tion | (Sabin/ft²) | tion |
| 100 | 0 | 8.1 | 0 | 0.11 |
| 126 | 11.4 | 4.7 | 0.16 | 0.07 |
| 160 | 7.9 | 3.8 | 0.11 | 0.05 |
| 200 | 7.6 | 2.6 | 0.11 | 0.04 |
| 250 | 15.6 | 2.5 | 0.22 | 0.03 |
| 315 | 17.2 | 1.7 | 0.24 | 0.02 |
| 400 | 21.2 | 2.2 | 0.29 | 0.03 |
| 500 | 22.9 | 1.5 | 0.32 | 0.02 |
| 630 | 22.9 | 1.3 | 0.32 | 0.02 |
| 800 | 23.2 | 1 | 0.32 | 0.01 |
| IK | 21.3 | 1.2 | 0.3 | 0.02 |
| 1.25K | 20.2 | 1 | 0.28 | 0.01 |
| 1.6K | 24.0 | 0.7 | 0.34 | 0.01 |
| 2K | 32.9 | 0.7 | 0.46 | 0.01 |
| 2.5K | 38.6 | 1.3 | 0.54 | 0.02 |
| 3.15K | 40.3 | 1.1 | 0.56 | 0.01 |
| 4K | 45.5 | 1.7 | 0.63 | 0.02 |
| 5K | 47.8 | 1.7 | 0.66 | 0.02 |

| | |
|---|---|
| Noise Reduction Coefficient (NCR) | 0.35 |

TABLE 2
PRESENT INVENTION BLINDS CLOSED

| Frequency | Absorption | Devia- | Coefficient | Devia- |
|---|---|---|---|---|
| (Hz) | (Sabin) | tion | (Sabin/ft²) | tion |
| 100 | 0.7 | 8.2 | 0.01 | 0.11 |
| 126 | 6.9 | 4.6 | 0.1 | 0.06 |
| 160 | 6.6 | 4.2 | 0.09 | 0.06 |
| 200 | 10.1 | 2.2 | 0.14 | 0.03 |
| 250 | 17.9 | 2 | 0.25 | 0.03 |
| 315 | 25.3 | 1.5 | 0.35 | 0.02 |
| 400 | 36.3 | 1.9 | 0.5 | 0.03 |
| 500 | 52.3 | 2.6 | 0.73 | 0.04 |
| 630 | 60.7 | 1.2 | 0.84 | 0.02 |
| 800 | 67.9 | 1.1 | 0.94 | 0.01 |
| IK | 68.5 | 1.3 | 0.95 | 0.02 |
| 1.25K | 65.8 | 1.3 | 0.91 | 0.02 |
| 1.6K | 58.1 | 1 | 0.81 | 0.01 |
| 2K | 49.9 | 1 | 0.69 | 0.01 |
| 2.5K | 49.6 | 1.2 | 0.69 | 0.02 |
| 3.15K | 55.4 | 1.3 | 0.77 | 0.02 |
| 4K | 55.4 | 1.3 | 0.76 | 0.02 |
| 5K | 52.8 | 2.2 | 0.73 | 0.03 |

| | |
|---|---|
| Noise Reduction Coefficient (NCR) | 0.65 |

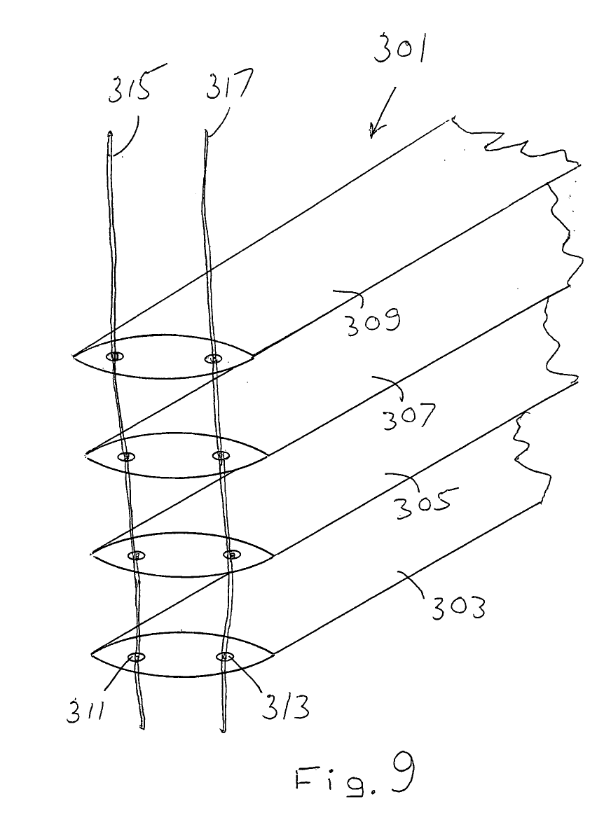

FIG. 9 illustrates a partial oblique view of another alternative preferred embodiment present invention sound absorbing blind system 301. Sound absorbing blind system 301 includes a plurality of blinds 303, 305, 307 and 309. Each of these blinds is unistructureally formed in any manor described above and has a homogenous color throughout. This is achieved by including a dye in the casting or extrusion materials to create a consistent color throughout. This will enable a manufacturer to custom cut blind lengths while maintaining the consistent color on exposed end portions.

Further, each of blinds 303, 305, 307 and 309 have receiving orifices such as orifices 311 and 313 for receiving pins connected to rods or cords such as cords 315 and 317. The rods or cords 315 and 317 will be connected to functional fittages (not shown) at the top with adjustment rods or cords that will enable a user to open or close the sound absorbing blind system 301 up and down as well as open or close the sound absorbing blind system 301 by rotation.

The present invention blind systems offer the user/designer the opportunity to create arrangements with a selection of materials of construction, shapes and sizes, and eliminate the need for rigid extruded plastic or metal blinds or blind substrates previously used, while providing increased sound absorption. The later advantageous present invention characteristic will be beneficial to both decrease sound reflection and decrease sound distortion, as has historically occurred in meetings, videoconferencing, teleconferencing and other interior space.

Prior to the use of the present invention systems, the largest source of untreatable sound reverberation and distortion (through additive and canceling effects of original and echoing sound waves) in meeting rooms and conferencing rooms has been window areas, including conventional window areas, even with conventional blinds closed. These problems have been significantly reduced with the present invention blind systems. While appearing the same as traditional blinds, the present invention blinds provide for absorption of 65% of incident noise (over 85% in the articulate speech frequency range) when closed and 35% absorption (over 40% in the articulate speech frequency range) when open.

An example sound absorbing blind system is described below. Seventy-five individual blinds are constructed from a layer of swirled mat fiberglass and a layer of partially open pore polyester foam. These two layers are joined together to create a unistructural blind member. A pair of end caps are fixedly attached to the two ends of each individual blind member as described above. Two chords are attached the each end cap to form an enclosure channel such that there are two parallel pairs of chords with the seventy-five blinds suspended between equidistant from each other to create a assembly of horizontal blinds. When the blinds are in the same plane as the chords, the edges of each blind overlap the edges of adjacent blinds to effectively block light and air from passing through. The two pairs of chords are attached to a support structure that is placed at the top of a window and secured with mounting plates or other support means common in the art. A rotable rod is connected to the support structure and blinds that moves one of each pair of chords to tilt the individual blinds 180° about their center lengthwise. This allows the blinds to transition from fully closed parallel to the chords, to fully open perpendicular to the chords, to fully closed and 180° from the first closed position. A chord and pulley system is also attached to the support housing and blinds that allows for the plurality of blinds to be raised or lowered to cover part of or all of the window surface. This sound absorbing blind system allows for adjustable control of sound, light and air movement between the two sides of the window as needed for a desired application.

To summarize, the present invention thus provides a window blind, doorway blind, divider blind or other blind that is opened and closed to permit/prevent light entry and/or create/remove privacy. More specifically, the present invention provides an unistructure blind systems of the above types wherein the blinds system advantageously absorbs sound to decrease echoing, reverberations, distortions, etc. in the surrounding environment without the need for rigid extruded plastic or metal blinds or blind substrates used in the art previously.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A sound absorbing blind system, which comprises:
(a) support means for a plurality of window blinds;
(b) operational means connected to said support means and to said plurality of window blinds for opening and closing said plurality of window blinds;
(c) said plurality of window blinds connected to said support means and said operational means, each of said plurality of window blinds being adapted for sound absorption, and each of said plurality of window blinds being an acoustically and insulatively absorptive, single layer material having a noise reduction coefficient of at least 0.60 when said plurality of blinds are closed.

2. The sound absorbing blind system of claim 1 wherein each of said plurality of window blinds is a unistructural blind that functions as a single element.

3. The sound absorbing blind system of claim 1 wherein said plurality of window blinds material is a fiber glass material selected from the group consisting of compression molded fiber glass, spun fiber glass and swirled mat fiber glass.

4. The sound absorbing blind system of claim 1 wherein said plurality of window blinds material is a foam material selected from the group consisting of at least partially open pore urethane foam and at least partially open pore polyester foam.

5. The sound absorbing blind system of claim 1 wherein said plurality of window blinds material is a mat material selected from the group consisting of inorganic mat, organic mat and combinations thereof.

6. The sound absorbing blind system of claim 1 wherein each blind of said plurality of blinds includes two opposing elongated enclosure channels that receive and hold peripheral edges of said blind.

7. The sound absorbing blind system of claim 1 wherein each blind of said plurality of window blinds has a thickness of about 0.15 inches to about 0.5 inches.

8. The sound absorbing blind system of claim 1 wherein said plurality of window blinds material has a density of about 4 pounds per cubic foot to about 9 pounds per cubic foot.

9. The sound absorbing blind system of claim 1 wherein said plurality of window blinds are selected from the group consisting of vertical blinds, horizontal blinds and angled blinds.

10. The sound absorbing blind system of claim 1 wherein said plurality of window blinds are constructed without the need for rigid extruded plastic or metal blinds or blind substrates.

11. A sound absorbing blind system, which comprises:
(a) support means for a plurality of window blinds;
(b) operational means connected to said support means and to said plurality of window blinds for opening and closing said plurality of window blinds;
(c) said plurality of window blinds connected to said support means and said operational means, each of said plurality of window blinds being adapted for sound absorption, and each of said plurality of window blinds being an acoustically and insulatively absorptive, multiple layer material having a noise reduction coefficient of at least 0.60 when said plurality of blinds are closed.

12. The sound absorbing blind system of claim 11 wherein each of said plurality of window blinds is a unistructural blind that functions as a single element.

13. The sound absorbing blind system of claim 11 wherein at least one of said plurality of window blinds materials is a fiber glass material selected from the group consisting of compression molded fiber glass, spun fiber glass and swirled mat fiber glass.

14. The sound absorbing blind system of claim 11 wherein at least one of said plurality of window blinds materials is a foam material selected from the group consisting of at least partially open pore urethane foam and at least partially open pore polyester foam.

15. The sound absorbing blind system of claim 11 wherein at least one of said plurality of window blinds materials is a mat material selected from the group consisting of inorganic mat, organic mat and combinations thereof.

16. The sound absorbing blind system of claim 11 wherein each blind of said plurality of blinds includes two opposing elongated enclosure channels that receive and hold peripheral edges of said blind.

17. The sound absorbing blind system of claim 11 wherein each blind of said plurality of window blinds has a thickness of about 0.15 inches to about 0.5 inches.

18. The sound absorbing blind system of claim 11 wherein said plurality of window blinds material has a density of about 4 pounds per cubic foot to about 9 pounds per cubic foot.

19. The sound absorbing blind system of claim 11 wherein said plurality of window blinds are selected from the group consisting of vertical blinds, horizontal blinds and angled blinds.

20. The sound absorbing blind system of claim 11 wherein said plurality of window blinds are constructed without the need for rigid extruded plastic or metal blinds or blind substrates.
